(19) United States
(12) Patent Application Publication
(10) Pub. No.: US 2010/0312466 A1
(43) Pub. Date: Dec. 9, 2010

(54) METHOD AND DEVICE FOR CALCULATING ALTERNATIVE ROUTES IN A NAVIGATION SYSTEM

(75) Inventors: Jochen Katzer, Gallmersgarten (DE); Mathias Mühlfelder, Wurzburg (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: NAVIGON AG, Hamburg (DE)

(21) Appl. No.: 12/711,324

(22) Filed: Feb. 24, 2010

(30) Foreign Application Priority Data
Feb. 26, 2009 (DE) 10 2009 010 382.1
Feb. 2, 2010 (DE) 10 2010 006 702.4

(51) Int. Cl. G01C 21/36

(52) U.S. Cl. 701/201

(57) ABSTRACT

The present invention relates to a device and a method for navigating a vehicle along a route from a starting position or an instantaneous position to a destination. To this end, a route calculation device of a navigation device calculates a route course which is composed of a sequence of several coherent roads stored on a digital map of a memory device as a first route, and additionally calculates at least one alternative route by allocating a penalty attribute, especially increased average traveling time, road distance or the like, to at least one road of the first route. The method comprises at least the following steps of:
S1: entering at least one destination;
S2: calculating a first route;
S3: allocating a penalty attribute to at least one road of the first route;
S4: calculating at least one additional route;
S7: representing the routes and selecting a route;
S8: navigational guidance along the selected route.

The present invention relates to a method and a device for navigating a vehicle along a route from a starting position or an instantaneous position to a destination, wherein a route calculation device of a navigation device calculates a route course which is composed of a sequence of several coherent roads which are stored on a digital map of a memory device as a first route. Moreover, at least one alternative route is calculated by allocating a penalty attribute, especially increased average traveling time, road distance or the like, to at least one road of the first route.

From the state of the art generic navigation devices are known which calculate a route between starting position and destination by entering a starting position or an instantaneous position as well as a destination. The route is calculated with the aid of a routing strategy, wherein the strategy pursues the target of optimization, which may be a minimum- distance route or most time-efficient route, or optimizes the route according to desired requirements, such as avoidance of freeways, toll roads or travel along road segments which are surrounded by beautiful scenery.

Moreover, it is known in up-to-date navigation devices that a selection of routes which satisfy different routing strategies is displayed to the user. Besides, navigation devices are known which are capable of taking into account in the route calculation traffic messages which can be captured for instance via a traffic messaging system, such as the RDS-TMC system, wherein traffic jam or traffic disturbance warnings can be output and bypass routes can be suggested. To this end, a bypass route is calculated when a traffic message affecting the currently traveled route lying ahead is received, and the user is navigated along the bypass route, whereby the user in most instances is incapable of manipulating the creation of the bypass route.

For instance from document EP 0 645 603 A1 a navigation device is known which is capable of calculating several routes between a starting position and a destination, wherein a first route is calculated and at least individual roads of the first route are deleted from a map in order to calculate additional routes.

Besides, document EP 1 172 631 A1 reveals a method for the route calculation of a navigation device, wherein a route is searched taking into account road types with specific properties, especially average travel speed on said road types, in order to provide an optimized route in accordance with user requirements.

The aforesaid methods fail to provide the user with an option to calculate one or more alternative routes with the aid of a predetermined routing strategy, such as fastest route or shortest route, wherein said alternative routes constitute real alternatives rather than only slight modifications of an initially calculated route. In addition, the aforesaid methods and devices fail to provide a transparent representation of several alternative routes for a user, in order to provide the user with the option to freely select between different concrete alternative routes, especially in bypassing traffic jams. Moreover, it is not known from the aforecited state of the art to take into account individual or average traffic flow speeds along roads for the calculation of one or more alternative routes.

One drawback of the method known from the relevant state of the art for calculating a plurality of routes resides in the aspect that the plurality of routes are not subject to a common routing strategy and fail to represent for instance fast connections, but rather frequently correspond to a routing strategy of a different type. Beyond that, it is disadvantageous that in the event of a routing strategy change, for instance from the shortest route to the time-optimized route, the same routes are frequently calculated, since for instance expressways constitute both the fastest route and frequently likewise the shortest route, so that a routing strategy change often fails to generate real alternative routes. Especially in traffic disturbance and traffic jam messages, in fact only one bypass option is provided, and this option cannot be manipulated on the part of the user, so that the user is required to rely on the automatically created bypass route. In this instance too, it is desirable to take into account different traffic flow speeds which regard driving behaviors of the relevant user, a group of users or time-of-day-specific traffic conditions.

The aforecited drawbacks are overcome by a method and a device according to the independent claims. Advantageous developments of the present invention are the subject-matter of the subclaims.

According to the invention, a method for navigating a vehicle along a route from a starting position or an instantaneous position to a destination is suggested, wherein a route calculation device of a navigation device calculates a route course which is composed of a sequence of several, coherent roads which are stored on a digital map of a memory device as a first route, and additionally calculates at least one alternative route by allocating a penalty attribute, especially increased average traveling time, road distance or the like, to at least one road of the first route. To this end, the method comprises at least the following steps of:

S1: entering at least one destination;

S2: calculating a first route;

S3: allocating a penalty attribute to at least one road of the first route;

S4: calculating at least one additional route;

S7: representing the routes and selecting a route;

S8: navigational guidance along the selected route.

According to the aforecited method, instead of one route obeying a predetermined routing strategy, a plurality of routes obeying said routing strategy are calculated and presented to the user. The user is provided with the option to accept one of the suggested routes and to travel along said recommended route. Moreover, dynamical content, such as traffic messages or traffic jam information can be taken into account in the calculation of the plurality of routes. Historical data, especially speed profiles of the user, can be taken into account in the calculation of the plurality of routes, whereby an enhanced recommendation of one or more routes is enabled on the basis of actual traffic flow speeds along roads of said routes.

The inventive method suggests calculating a plurality of routes which constitute a concrete alternative to a first calculated route and which satisfy a common routing strategy, especially fastest route, shortest route or route passing along places which are especially worth seeing etc. In determining the alternative routes, traffic messages, such as messages relating to traffic jams or traffic disturbances, can be taken into account and route alternatives which satisfy the previously selected routing strategy and which constitute real alternatives to the first route can thusly be suggested, wherein the user is provided with transparent alternative routes, and historical data of the user or group of users can be taken into account, and routes other than those provided by the conventional navigation devices are provided, so that a route can be selected which will not equally be selected by most of the other traffic participants.

According to the invention, the alternative routes are identified by the aspect that starting from a first route, roads, i.e. road elements, of the first route are allocated penalty attributes, especially virtually increased traveling time or virtually increased travel distance, so that in the application of the routing algorithm said roads are not regarded as optimal roads for an additional route. By means of this measure, it is possible to identify alternative routes which do not pass along the roads of the first route. By allocating penalty attributes to the roads of the first route or the precalculated routes, said roads are discarded by the routing algorithm as being disadvantageous as a function of the routing strategy, so that concrete alternative routes to the previously calculated routes can be identified.

According to an especially preferred exemplary embodiment of the method, the following intermediate steps are taken into account:

S5: comparing and evaluating the additional route with respect to the precalculated route or routes, especially in regard of the route distance, traveling time, number of identical roads or the like;

S6: deciding whether or not to calculate an additional route as a function of the evaluation result, especially with respect to identity of roads, route distance, traveling time, subject to a predeterminable absolute or relative measure, and/or deciding whether or not to discard the additional route as a function of the evaluation result.

In this connection the penalty attributes can be adapted for another route calculation. Moreover, the method can be performed until a predeterminable number of alternative routes, preferably three alternative routes, have been calculated. Thus, said first example suggests an iterative calculation of routes until for instance a predetermined and desired number of alternative to routes which satisfy the underlying routing strategy have been identified. When these route alternatives have been calculated, said alternatives are displayed to the user, preferably with evaluation information on the respective route alternative, especially route distance, estimated traveling time and/or predicted time of arrival. In this context for instance available traffic information, such as traffic jam messages or traffic disturbances along the route, can be indicated to the user. By means of this aspect, the user is provided with the option to select one alternative route among the plurality of different route alternatives and to use said alternative route for navigational guidance. By means of the iterative calculation of several route alternatives, in which at least road sections of the precalculated route or routes are allocated penalty attributes, especially artificially decelerated travel speed along the road or virtually increased road distance, said road sections are rendered unattractive for the routing algorithm to the extent that said algorithm will search real route alternatives to the artificially deteriorated precalculated routes. Thereby, a calculation of a concrete alternative route in addition to the precalculated routes is enabled. This comparison may for instance be based on the aspect that roads which are common roads of precalculated routes are identified and the number of said roads is regarded in relation to the total number and in relation to the non-common elements of the precalculated route. If said relation exceeds a predeterminable threshold value, the currently calculated route is regarded as being too similar to the precalculated routes and is thusly discarded, whereupon another calculation can be performed, especially subject to increased penalty attributes. Alternatively and/or additionally thereto, the road distance or the desired traveling time along common road elements can be equally regarded in relation to the total number and in relation to the non-common road elements in order to use this aspect as a decision criterion underlying the recalculation or discardal of a route. By increasing to the penalty attributes on road segments of the precalculated routes, the routing algorithm is compelled to identify routes which, at least in the majority of roads, differ from the precalculated routes. In this context, it is well conceivable that, if the penalty attributes exceed a certain degree, the route is identified as being too dissimilar and hence too unattractive for the user and is thusly discarded, whereupon the iterative calculation of additional routes can be terminated. In contrast thereto, the aforesaid degree of variation can also be considered to the extent that if a predeterminable threshold value is undershot, the currently calculated route is regarded as being essentially equal or too similar to the precalculated routes and hence fails to constitute a real alternative, so that said route is discarded and/or another calculation can be performed subject to increased penalty attributes. By manipulating the amount of penalty attributes, on the one hand it is thusly possible to identify concrete alternative routes and on the other hand it can be ensured that the identified routes are not essentially unattractive for the user, since these routes no longer satisfy the original routing strategy.

In connection with the aforecited exemplary embodiment two criteria for calculating alternative routes are to be considered.

On the one hand, the iteration of another route calculation can be terminated if another sensible route which satisfies the predetermined routing strategy apparently cannot be identified.

On the other hand, the amount of penalty attributes of the precalculated route or precalculated routes can be increased, in order to render the identification and use of these roads more improbable for the currently calculated route. In this context, it is conceivable to allocate penalty attributes to the roads of all precalculated routes or else to allocate penalty attributes only to the roads of the previously calculated routes, wherein the latter instance involves the risk that roads of the routes other than the previously calculated route may be used in the calculation of the currently traveled route. The penalty attributes may sum up from one routing calculation iteration to the next routing calculation iteration for the roads of the previously calculated routes. Here, it may be conceivable to add a constant penalty attribute to the road, e.g. a 10% or 5 minute increase in traveling time or a 10% or 2 km increase in road distance. Besides, it is also conceivable that the penalty attribute obeys a tabular allocation or functional specification, such as an exponential function or a polynomial function, wherein the penalty attributes can be a function both of the characteristics of the road (distance, predicted traveling time, percental dependency) as well as of the number of already calculated routes.

According to an advantageous development a combination of both implementable variations can be performed by initially increasing for instance the penalty attributes in the calculation of the first route alternative until a sensible route alternative has been identified, while in the search for a third or further alternative, the iteration may be terminated if another sensible route which satisfies the predetermined routing strategy apparently cannot be identified. In this way, it can be ensured that at least one routing alternative is identified, wherein the identification of two or three alternative routes depends upon the current road topology. Hence, the inventive method can identify only one individual alternative route as a function of the location of the road and display said alternative route to the user or can display to the user two or more alternative routes for selection. In this connection, it is especially advantageous to treat the penalty attribute for individual roads not as a constant value or as a percental penalty attribute value, for instance increased traveling time or travel distance, but rather to adapt the penalty attribute as a function of the previously identified route evaluation in a dynamical fashion or to adapt the penalty attribute in the form of a table or a functional mathematical specification as a function of the minimum or maximum deviation criterion, for instance as being similar or dissimilar.

With respect to the aforecited exemplary embodiment, wherein a comparison and an evaluation of the additional routes are performed, it is especially advantageous to carry out an analysis of the routes in terms of their suitability with respect to the routing strategy, wherein a specific value is determined taking into account the road distances and the estimated traveling times along roads of the previously calculated route. Said specific value may be determined for instance using the following formula:

$${K}_{r} = {f}_{s} \cdot {\sum }_{{seg}_{r}} s + {f}_{t} \cdot {\sum }_{{seg}_{r}} t$$

wherein Kᵣ represents a specific value of a route r which comprises a number of segments segᵣ, wherein s represents the distance of each segment and t describes the estimated traveling time along the segment. fₛ constitutes a distance factor which has an impact on the weighting of the road distance with respect to the specific value. fₜ constitutes a decision factor which regards the weighting of the traveling time with respect to the specific value.

By weighing the specific values fₛ and fₜ against one another, the routing strategy can be regarded as shortest route (fₛ large in contrast to fₜ) and fastest route (fₜ large in contrast to fₛ) in the calculation of the specific value. For instance in the routing strategy “fastest route”, the factors fₛ and fₜ are selected in such a manner that fₜ is particularly large in contrast to fₛ, whereas in the strategy “shortest route”, fₛ should be selected so as to be large in order to increase the impact of the road distances on specific value Kᵣ. In this connection, it is conceivable that according to the magnitude of the specific values, wherein a minimal specific value represents optimum suitability of a route in terms of the routing strategy, the routes are displayed to the user in an ordered fashion.

According to another advantageous exemplary embodiment, the individual driving behavior, especially time-of-day-related and day-of-the week-related driving behavior of a user and/or a group of users, can be considered in the calculation and/or evaluation of a route in terms of roads and/or road types. Hence, in the calculation of a route or an alternative route, the actual traffic flow speed of the user or a group of users can be incorporated into the calculation, and impacts of times of day, weekends or working days, actually traveled average speeds on a certain road type, such as freeway, national highway, highway or in-town roads, can hence be taken as a basis for determining the suitability of a road for the calculation of a route. By means of this measure, for instance the estimated times of arrival (ETA) can be determined on the basis of the calculated routes, wherein the calculated routes are the result of the predicted traveling times along the roads of the respective route and the individual times of departure, and wherein individual or else collectively gathered empirical and historical traffic flow speeds of the respective road and speed classes can be regarded primarily for certain time intervals, times of day and days of the week. The historical data of a group of users may for instance be downloaded in the data update of the navigation device or by means of an online or live connection of a navigation device via the Internet or a radio network, such as GSM, GPRS, UMTS etc, via a central server for certain road types, and a user's own travel speed data of roads can be provided for third-party user updates, so that the historical data of a group of users can be allocated to individual roads in order to be capable of taking into account their traffic flow speeds or traveling times in the calculation of a route.

Starting from the aforecited calculation operations, the traveling time t on a road may be a dynamical value which is a function of the day of the week, time of day or driving behavior of an individual user or a group of users. Historical traffic flow speeds of the user or a group of users form the basis of said dynamical traveling time along a road, and these can be individually stored for individual road categories, preferably as a function of the time of day and/or day (weekday, working day, public holiday). The data of a plurality of users may be regularly downloaded from a central server in a wireless or wire-bound fashion for instance together with map data either via UMTS, WLAN, WiMax or Bluetooth or else in the update of the navigation device. The specific value of a route with dynamic road information can be derived using the following formula:

$${K}_{r} = {f}_{s} \cdot {\sum }_{{seg}_{r}} s + {f}_{t} \cdot {\sum }_{{seg}_{r}} {t}_{d y n} ,$$

wherein t_{dyn} represents a dynamical traveling time which can be selected as a function of the time of day, type of day or individual user/s or group of users. Here, the route which features the lowest specific value equally constitutes the recommended route and the sequence of the suggested alternative routes may be determined by the magnitude of the specific value. Hence, the recommendation of a route of preference may in fact deviate from an inflexible calculation which does not regard individual user data or historical values, so that for instance similar navigation devices using similar methods may nevertheless calculate and suggest different routes as a function of the driving behavior of the user or group of users.

According to another advantageous exemplary embodiment the penalty attributes may be determined in an adaptive fashion at least for individual road types, such as freeways, expressways, highways, residential roads or the like, especially for individual roads of a route, and/or the penalty attributes for individual road types or individual roads can be determined as a function of the individual driving behavior of a user or a group of users. According to this alternative, it is suggested that in allocating penalty attributes to roads of precalculated routes, the characteristics of the road type as constituting a freeway, expressway, highway, residential road or the like are regarded and different penalty attributes, which are stored for instance in a table, are used for said road types.

Moreover, it may be advantageous that the penalty attributes are based on historical driving behavior values of a user or group of users, for instance if a user prefers to travel along highways or freeways or if average traffic flow speeds on freeways are significantly higher or lower than those on expressways or highways or residential roads, so that on the one hand, a user's preference for a certain road type is discernible, and on the other hand, a deviating driving behavior of a user or group of users on different road types is discernible, so that said road types can be evaluated as being advantageous or disadvantageous with the aid of penalty attributes. Hence, said exemplary embodiment suggests to allocate penalty attributes according to a certain logic and to allocate penalty attributes to roads of one or several precalculated routes which are adapted to the type of the road element so that a variable allocation of penalty attributes along the roads of precalculated routes is enabled. Hence, most routes start out on a side road, for instance in a residential zone or on a highway, however, for the most part of the route they pass along roads of higher road categories, such as freeways or expressways, and terminate again in side roads, such as residential zones or highways. For taking a decision on an alternative route it is thusly advantageous to allocate increased penalty attributes to particularly long roads which pass along road types of higher classes, such as freeways or expressways, compared to road types of lower road classes, such as highways, residential zones etc. proximate to the starting positon or destination. In this context, it may be advantageous that the penalty attributes are set to zero in residential zones in order to avoid that a to destination is reached using uncommon roads instead of using a main road via a residential road.

Relying upon the considerations set out above, another advantageous exemplary embodiment suggests that the penalty attributes of each road shall be determinable as a function of the distance from the starting position and/or destination and/or as a function of a road type structure of a route. Thus, it is advantageous to evaluate the road elements proximate to the starting position, the instantaneous position and/or destination with a very small penalty attribute of or no penalty attribute whatsoever in order to avoid that the destination is reached using uncommon roads. Besides, it is advantageous to allocate an increased penalty attribute to roads which are located in the middle of the route in order to be able to identify an extensive bypass road in contrast to the precalculated route. As a consequence, the plurality of calculated alternative routes will use identical roads proximate to the starting position and/or destination. However, significant variations will be discernible in the midsection of the route.

In-town routes are composed of multiple, individual short roads, wherein the total distance is relatively short and the traveling time, however, is comparatively long due to the low average speed. In a supraregional route, for instance from one town to the next town via a freeway, however, in the midsection of the route a large number of long road elements will be traversed, whereas short road elements are located at the start and at the end. In the latter case, an uneven distribution of the penalty attributes is advantageous, wherein the road elements located in the middle of the route are allocated increased penalty attributes, whereas the first and ultimate road elements are allocated a penalty attribute of a mere e.g. 5%, so that an extensive bypass road leading away from the long freeway elements can be identified, wherein the in-town road elements at the starting position and destination are hardly affected. This aspect is preferable especially in a distance-based routing strategy.

Moreover, instances may occur where certain road elements must not be allocated penalty attributes, since said road elements may constitute the only possible and sensible connection between starting position and destination, especially ferries, bridges, tunnels or mountain passes. The is travel via a ferry or a bridge generally constitutes the only possible option to reach a destination without any greater loss of time and distance, so that said “chokepoint road types” reasonably should not be allocated increased penalty attributes. Hence, an analysis of a road type structure, i.e. the sequence of roads of different road types along the route, may render meaningful information on how to allocate the penalty attributes in a selective manner in order to be able to identify reasonable alternative routes. If the user decides to configure a route so as to pass along distinctive points of reference, such as towns, lakes or places of interest, it is in fact expedient to allocate a small penalty attribute or no penalty attribute whatsoever to proximate road sections at the corresponding locations in order to compel the route algorithm to allow alternative routes to equally pass along said points of reference.

With respect to taking into account the individual driving behavior of a user for individual roads, it is expedient if the driving behavior of a navigation device is permanently recorded and if the speed parameters of a road are adapted for this purpose to the individual driving behavior of a user. The recorded driving behavior, especially traveling time and speed with respect to the time of day and day of the week, can be communicated to a driving behavior server which may transmit said information in the form of user group information to third-party users so as to enable enhanced alternative route identification.

According to another preferred exemplary embodiment the representation of the route course may comprise graphical, especially colored, route course to markings as well as different route markings, especially different route representation widths, in the event of overlapping roads, and/or may comprise a textual representation of the route evaluation information essential for the routes, especially route distance, traveling time, time of arrival, road types and/or traffic status information, such as traffic jams or traffic disturbances along the route. Thus, frequently two or more routes are identified which use identical road sections. In the graphical representation it is thusly especially advantageous to mark the individual alternative routes in color, so that a user may get a picture of the course of the individual routes in order to be able to select a route of preference. In the event of identical road sections, i.e. overlapping roads, it is advantageous to represent a road located below using a thicker line than that of a road located above, so that identical road sections are marked using different route representation widths of the individual routes in order to signalize that said roads are traversed by several routes. With respect to a textual representation of the routes it is especially advantageous to communicate to the user essential evaluation information which is advantageous for the selection on the part of the user, such as route distance, traveling time or predicted time of arrival, as well as potentially available traffic status information affecting road sections of said route, such as traffic jams or traffic disturbances. Such graphical as well as textual information representations make it easier for the user to select the correspondingly most convenient alternative route.

According to an advantageous exemplary embodiment information about traffic jams/traffic disturbances is received for each calculated route via a traffic messaging system, especially RDS-TMS, GSM, GPRS, UMTS, HSDPA, WLAN, WiMax, Bluetooth or the like, is represented specific to each route and is incorporated into the penalty attribute determination and/or evaluation of the route. Hence, the method detects traffic to information for each calculated route with respect to roads which are contained in said routes and evaluates said traffic information and takes said traffic information into account in the determination of penalty attributes for the calculation of additional alternative routes. Said information can be displayed to the user in order to indicate that traffic disturbances are to be expected on this route.

Generic navigation devices generally feature a reception interface for dynamical traffic messages which are preferably received via a RDS-TMC channel. Moreover, devices are already available which feature a wireless reception device in line with a WLAN-standard or based on mobile communication technologies, such as GPRS, UMTS or HSDPA. Besides, solutions are available which receive at least information on predicted, regular traffic disturbances in a wire-bound fashion by means of the Internet via an update server. Hence, navigation devices are capable of providing an overview of the traffic situation, especially using a currently calculated route. Said exemplary embodiment suggests that already at the time of the route calculation, relevant traffic information is received along the calculated alternative route and said traffic information is displayed to the user in the calculation of penalty attributes, in the comparison with precalculated routes and in the representation in order to regard the current traffic situation in the calculation, selection and evaluation of routes. In this connection, it is conceivable that the number of the traffic jam massages considered is displayed to the user with respect to each route in the form of an auxiliary means. In taking into account the current traffic situation it is necessary to represent said information of a traffic message in the form of a time loss value, wherein the time loss value may be regarded as a penalty attribute allocated to individual road sections. Moreover, such a time loss value has an impact on the estimated time of travel and estimated time of arrival and enables a realistic prediction of the traveling time. Such a time loss value may be communicated via the traffic information system and characterizes the type and duration of a disturbance.

Traffic messages in line with the TMC-standard typically contain an event code and a location code. The event code contains information which is included in standardized event code tables and which provides information on the type of message and, insofar as included, on the duration. In this connection, it is conceivable to perform an allocation of increased time of travel and road distance to each event code, in order to provide in a non-volatile memory of a navigation device for instance an event code table which allocates a time loss value to an event code. Event codes which are not indicative of a disturbance are not allocated penalty attribute values and can be represented as standard values, e.g. as percental deceleration over a short distance. If, for instance a traffic message with an event code E relating to a traffic jam of 5 kilometers is available, a time loss value can be calculated on the basis of the event code using different methods:

According to a first alternative, a deceleration value may be assumed e.g. for 20% of the usual traveling time on the road over a distance of 5 kilometers. The road of the route section affected by the traffic message for instance features a weighted average speed of 100 km/h. By means of the deceleration value of 20%, the speed is reduced to 20 km/h. Each kilometer which is traveled at 20 km/h instead of 100 km/h requires a 144-second time increase, wherein a traffic disturbance over a distance of 5 kilometers results in a time loss value of 12 minutes.

Alternatively to the aforecited option for calculating a time loss value, a predeterminable delay time can be regarded for a certain event code, or else a constant average speed can be allocated to said event code. In case of a predeterminable delay time per event code, the delay time is regarded in the form of a time loss value for the event on a road of a route. In case of a constant average speed, the speed allocated to the event on the road section is compared with the weighted average speed. If a speed of 50 km/h for the event is recorded, the travel may require an additional time of 72 seconds per kilometer, whereby a time loss value of 6 minutes over a distance of 5 kilometers is obtained in contrast to a typical average speed of 100 km/h. The aforecited three alternatives may occur in an event code table in combination and may be alternatively used when taking into account the time loss value. In case no information is available for an event, a constant predetermined time loss value can be assumed. Taking into account the time loss value, an estimated time of arrival can be determined which would be required to be considered in the selection of this route. Said time loss value may be taken into account especially in the calculation of the specific value Kr and provides a recommendation as to whether said route could be selected as a route of preference. To this end, the aforecited formula shall be modified so that the specific value Kᵣ can be calculated according to the following formula:

$${K}_{r} = {f}_{s} \cdot {\sum }_{{seg}_{r}} s + {f}_{t} \cdot ( {\sum }_{{seg}_{r}} t + {\sum }_{{seg}_{r}} Z ) ,$$

wherein Z is the sum of the time loss values of the individual road sections on said route. In this instance too, historical traffic flow speeds of the user or a plurality of users can be considered as a function of the time for certain road categories. The time loss values Z of said road sections of the route take into account the traffic messages on the respective route and are incorporated into the time of arrival and traveling time. The route with the lowest specific value Kᵣ hence constitutes the route of preference.

According to another advantageous embodiment, upon reception of a traffic message, additional routes for bypassing the traffic jam/traffic disturbance can be calculated with respect to the instantaneous route and based on the instantaneous position, wherein in addition, the instantaneous route can be represented as one of the alternative routes. Hence, said exemplary embodiment suggests that during a travel along an instantaneous route, an incoming traffic message affecting a road on said route triggers the start of the inventive method, wherein based on the instantaneous position, several alternative routes corresponding to the aforementioned exemplary embodiments can be calculated, wherein in turn traffic jam and traffic disturbance information is regarded in the calculation of said routes. As a consequence, a simple and short bypass route of the road on which the traffic obstacle is located is not suggested, but rather a complete recalculation of alternative routes is suggested which is performed according to the invention and which is initiated upon receipt of a traffic message on the instantaneous route.

In addition, upon receipt of a traffic message affecting the currently traveled route, the instantaneous route affected by the traffic message may still be suggested as route alternative, and besides, additional route alternatives can be calculated. Thus, the user may likewise decide to stay on the currently traveled route in order to anticipate the further development of the traffic jam/traffic disturbance, which may already have dissolved upon arrival at the traffic jam.

According to another advantageous exemplary embodiment, in the representation of the calculated routes, a route marked with respect to a preference criterion, especially shortest or fastest route, is recommended as route of preference, wherein especially in the selection of the route, the route of preference can be selected as instantaneous route subsequent to a predeterminable selection time in which a selection on the part of the user is not performed. Hence, this exemplary embodiment suggests that the route with the smallest specific value K is displayed to the user as recommended route of preference, wherein subsequent to a predeterminable selection to time, said route is automatically selected as instantaneous route, insofar as a selection is not performed on the part of the user. This recommendation can be displayed to the user by optical marking or sorting of alternative routes. Here, the sorting is based on the magnitude of the specific value Kᵣ. In the event of non-interaction on the part of the user, a route optimally adapted to a routing strategy can hence be automatically selected as route of preference for the instantaneous navigation operation so that only minimal user interaction with the navigation device is required to select the optimal route.

According to another aspect, the invention relates to a navigation device for performing a method according to any of the aforementioned exemplary embodiments. For this purpose, the navigation device comprises the following:
an input device for inputting at least one destination of a navigation operation;
a position determining device for determining an instantaneous position of the vehicle;
a memory device for storing at least road courses of a digital map and the calculated routes;
a route calculation device for calculating a route between a starting position or an instantaneous position and a destination, especially by inputting a route calculation requirement, such as travelling-time-minimized or distance-minimized route or the like;
a navigational guidance device for continuously determining navigational instructions during the travel of the vehicle along a selected route;
an output device for outputting a representation of at least two routes and for outputting navigational instructions;
a penalty attribute allocation device for allocating penalty attributes, such as additional road distance or additional traveling time to at least one road of at least one precalculated route.

According to the invention, the route calculation device is configured to calculate at least two routes between starting position or instantaneous position and destination taking into account the route calculation requirements, and the penalty attribute allocation device is configured to allocate penalty attributes to at least individual roads of at least the first route subsequent to the calculation of a first route so that in an additional route calculation, an alternative route can be calculated.

In other words, an inventive navigation device comprises a position determining device, a memory device, a route calculation device, a navigational guidance device and an output device as already known from the state of the art. In addition, the navigation device comprises a penalty attribute allocation device which is capable of allocating penalty attributes, such as retarded traveling time or increased travel distance, to at least individual roads of at least one precalculated route, in order to render said roads unattractive for the selected routing algorithm in the course of an additional calculation of the route calculation device so that the route calculation device is capable of identifying a real alternative route to the initially calculated route, wherein roads of the precalculated routes are largely disregarded. Moreover, the memory device comprises a map memory in which the roads of a digital map are stored, which can be combined by means of the route calculation device to form a route from a starting position or an instantaneous position to a destination, as well as a route to memory for storing the at least two calculated routes.

An inventive navigation device enables the calculation of at least two alternative routes, wherein by means of allocating penalty attributes to individual roads of a first calculated route, said roads are rendered unattractive for another calculation by the route calculation device to the extent that the route calculation device searches roads other than those used in the first route in order to calculate the alternative route. However, the alternative route is based on a predetermined routing strategy, such as for instance shortest distance or minimum traveling time.

According to a special embodiment of the navigation device the device comprises a route evaluation device for evaluating properties of the precalculated route or precalculated routes, especially in terms of route distance, traveling time, number of identical roads or the like, wherein the penalty attribute allocation device is configured to allocate modified penalty attributes to at least individual roads of the precalculated routes on the basis of an evaluation result. Hence, it is in fact conceivable that the route evaluation device recognizes a plurality of common road sections of the second or more precalculated routes and allocates to the same increased penalty attributes in contrast to the other roads in order to make it more difficult to exclude said common roads in another route calculation.

Moreover, the route evaluation device makes it possible to reduce the penalty attributes for individual roads which pass along proximate to the instantaneous position, starting position or destination in order to thusly avoid reaching a destination using uncommon roads. If the route evaluation device has recognized that a user prefers to travel along a freeway or expressway, the penalty attributes may be lower for said road categories than in case of other road categories, such as highways or side roads. The evaluation device may regard predefinable threshold values, especially a threshold value indicative of too great a resemblance to the precalculated routes and a threshold value indicative of too large a deviation from the precalculated routes. Hence, in the event of a high degree of identity of the roads and traveling times or route distances of a calculated route with precalculated routes, said route may be discarded due to too great a resemblance, for instance due to 80% road distance identity. On the other hand, a route may likewise be discarded in the event of too large a deviation in terms of the route distance or traveling time, for instance due to an 80% increase in traveling time or route distance, since in both instances, no real alternative routes could be identified, but routes which are either nearly identical or afflicted with inacceptable drawbacks on the part of the user regarding the selected routing strategy.

According to another preferred exemplary embodiment the input device comprises a selection means for selecting a route and a timing means for automatically selecting a route of preference. The precalculated routes are displayed to the user in the form of a list, especially in a categorized fashion and in terms of their suitability with respect to a routing strategy, i.e. for instance shortest route or fastest route. For this purpose, it is suitable to perform a priorisation of the routes according to the above illustrated specific value K. The time-optimized and/or distance-optimized route or the route optimally adapted to a routing strategy can be output as route of preference, i.e. “MyRoute”, and the user can be provided with the option to select one of the listed routes as currently traveled route. Using the selection means, the route of preference, i.e. “MyRoute”, can be automatically selected, insofar as the user does not make a selection within a preset time interval, so that the interaction between user and navigation device can be minimized and an optimal route is selected according to the user requirements.

According to another preferred exemplary embodiment the memory device may further comprise a road profile memory for storing an individual driving behavior, especially time-of-day-related driving behavior of a user and/or a group of users on at least one road. In this context, the driving behavior along a road can be recorded and stored in the road profile memory especially during a travel, and a road-related driving behavior can be retrieved from the road profile memory in the route planning. Taking into account an individual driving profile of a user or a group of users, for instance in the exchange in GPS positional data update and map update, the driving behavior of a user or a group of users can be stored with respect to individual roads. However, the road profile memory stores typical driving behavior properties, such as high travel speed, average traveling time along a road, so that the route is based on actual driving behavior properties rather than on predetermined properties. By means of this measure, it is possible to provide the user with more realistic and individually adapted route plannings. The driving behavior can be allocated a time stamp in terms of the time of day, day of the week, public holiday or the like. Hence, for instance on a road which can be traveled at a relatively high speed at noon or in the evening hours, relatively low travel speeds may be expected in the morning hours, so that in the morning hours a road other then the one regarded should be given preference in the route planning. By means of this measure, the rote planning simulates a close-to-reality driving behavior along a route and allows providing the user with optimized navigational guidance.

According to another preferred exemplary embodiment the navigation device comprises a communication device for wireless or wire-bound communication of an individual driving behavior and/or driving behavior of a group of users on at least one road between a road profile server and a remote central driving behavior server, wherein the communication device is capable of communicating with a driving behavior server via GSM GPRS, UMTS, HSDPA, WLAN, WiMax or the like in particular in a wireless to fashion or via LAN, the Internet, USB or the like in a wire-bound fashion. According to this exemplary embodiment, for instance the driving behavior of a driver can be constantly recorded during a travel on individual roads, and upon connection of the navigation device to the driving behavior server via the communication device, said data can be uploaded and the data of a group of users can be downloaded into the road profile memory in order to obtain updated information on the driving behavior on individual roads in order to thusly enable optimized close-to-reality route guidance.

Other advantages will become apparent from the following description of the drawings. In the drawings, exemplary embodiments of the present invention are illustrated. The drawings, the specification and the claims contain various features in combination. It will be appreciated by those skilled in the art to contemplate said features also in isolation and to use the features for realizing further sensible combinations.

In the drawings:

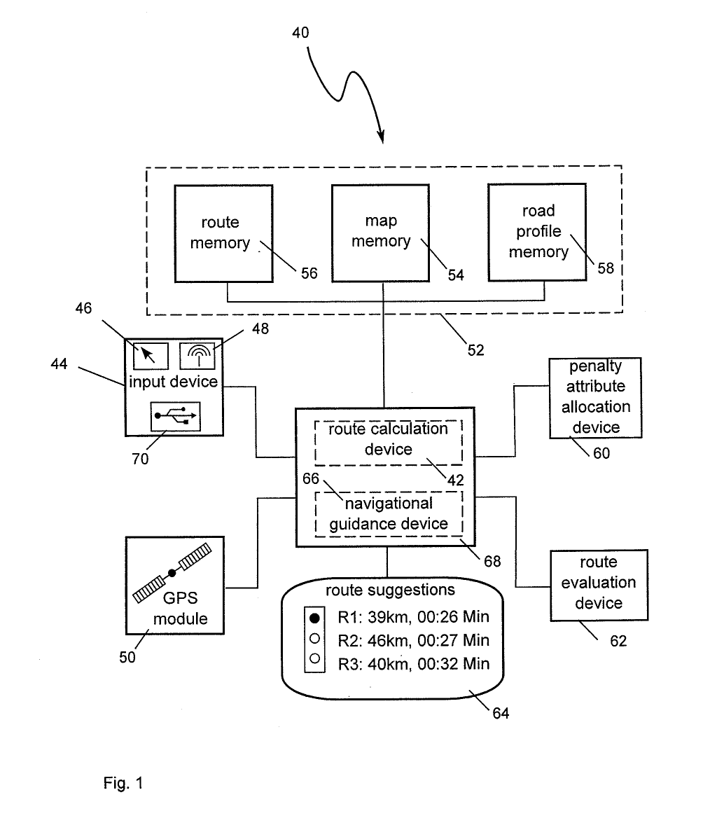

FIG. 1 shows a block diagram of one exemplary embodiment of the inventive navigation device;

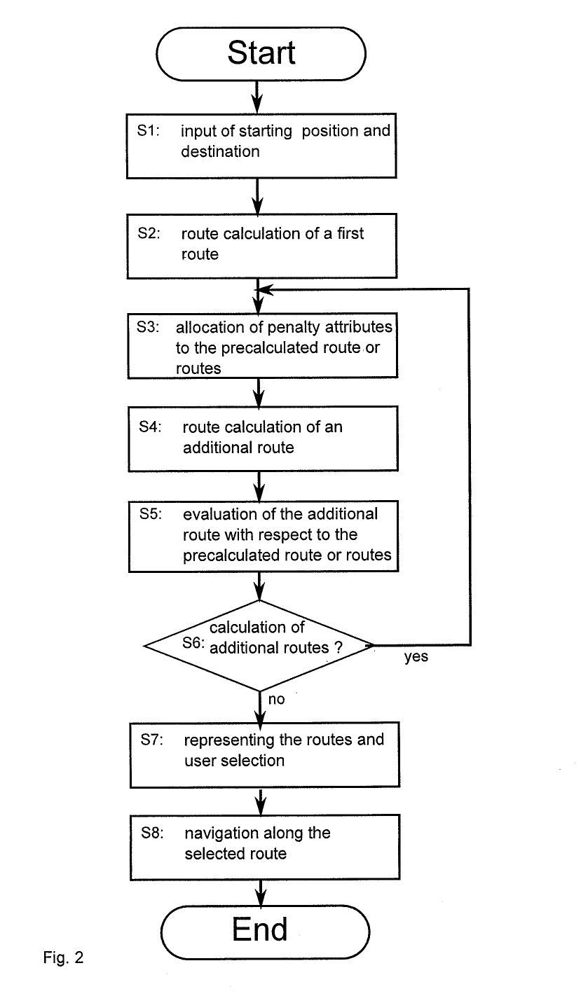

FIG. 2 shows a flowchart of a first exemplary embodiment of an inventive navigation method;

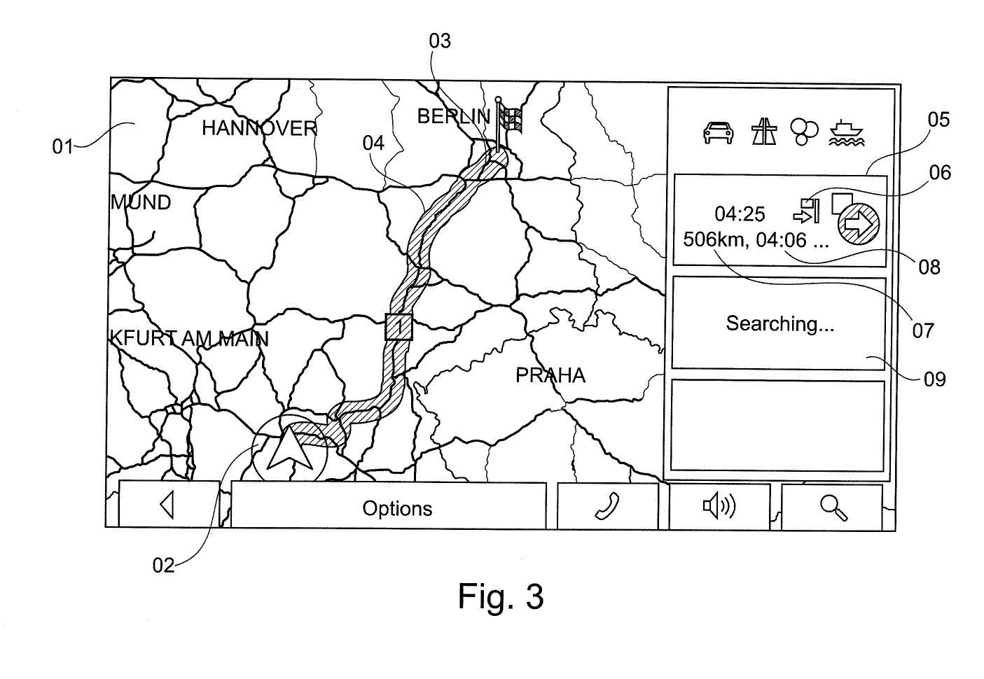

FIG. 3 shows an exemplary view of a graphical display of a navigation device subsequent to the calculation of a first route;

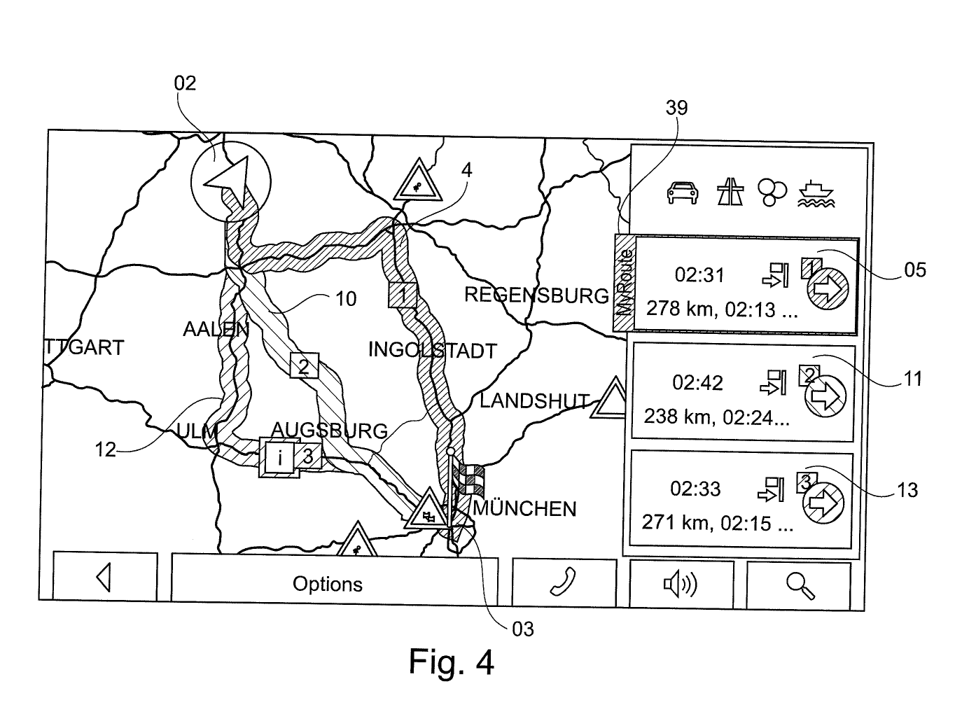

FIG. 4 shows another display of a navigation device subsequent to the calculation of three alternative routes;

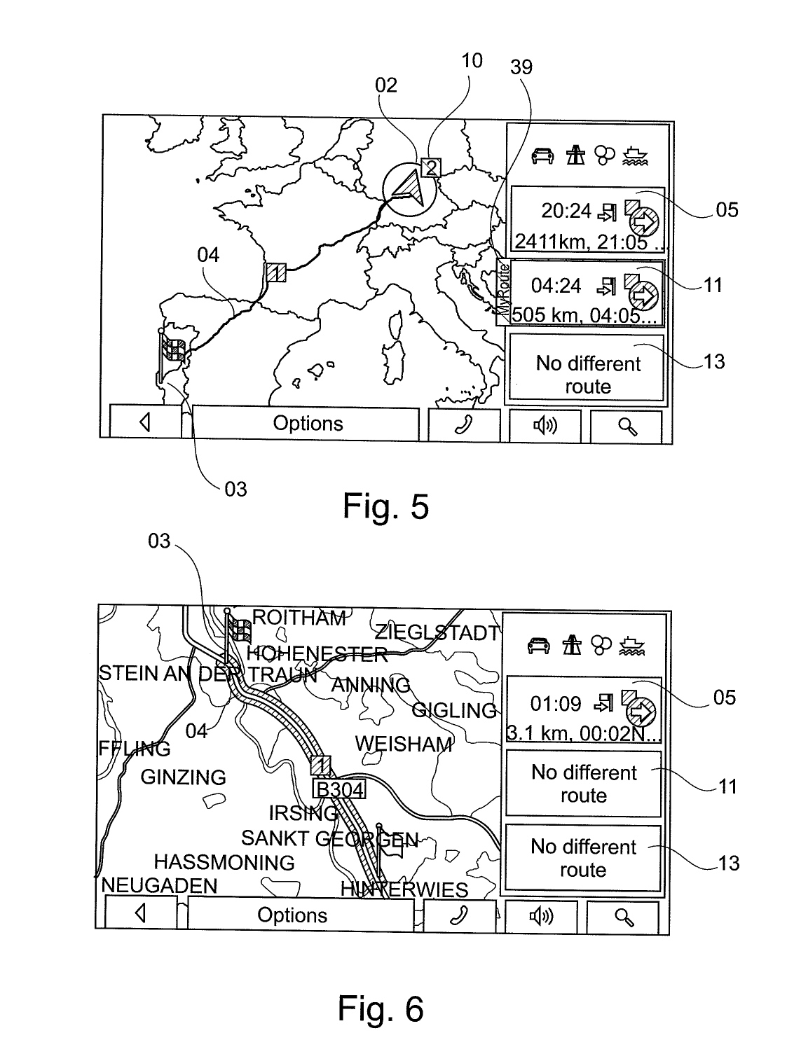

FIG. 5 shows a view of another navigation display subsequent to the calculation of two alternative routes;

FIG. 6 shows another display of an inventive navigation device, wherein no alternative route could be identified;

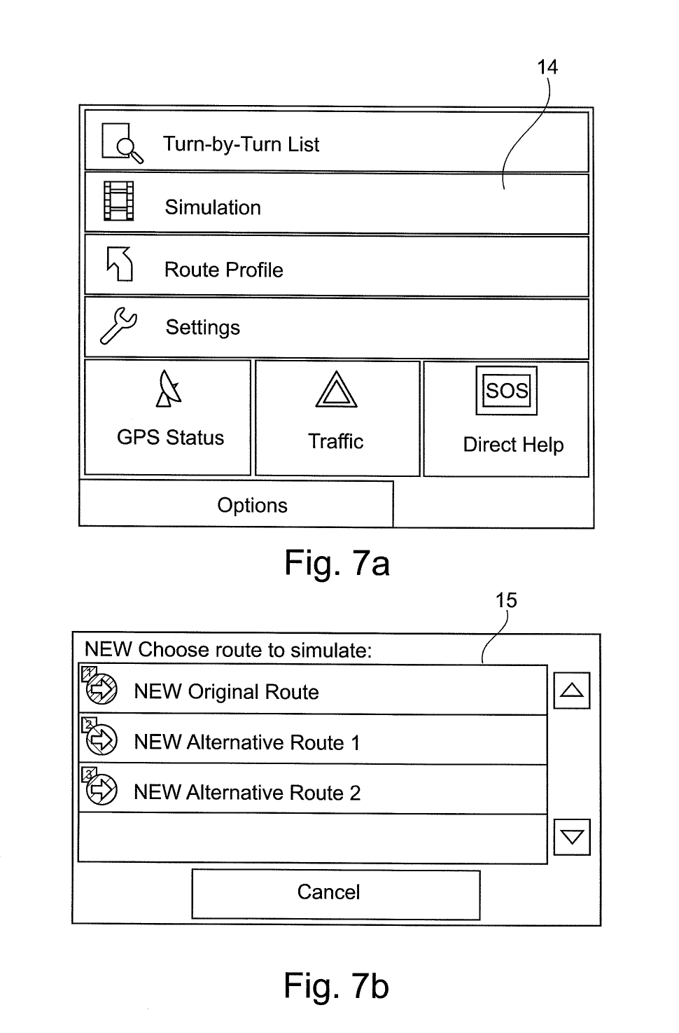

FIG. 7 shows selection menus for selecting alternative routes for a simulation according to an exemplary embodiment;

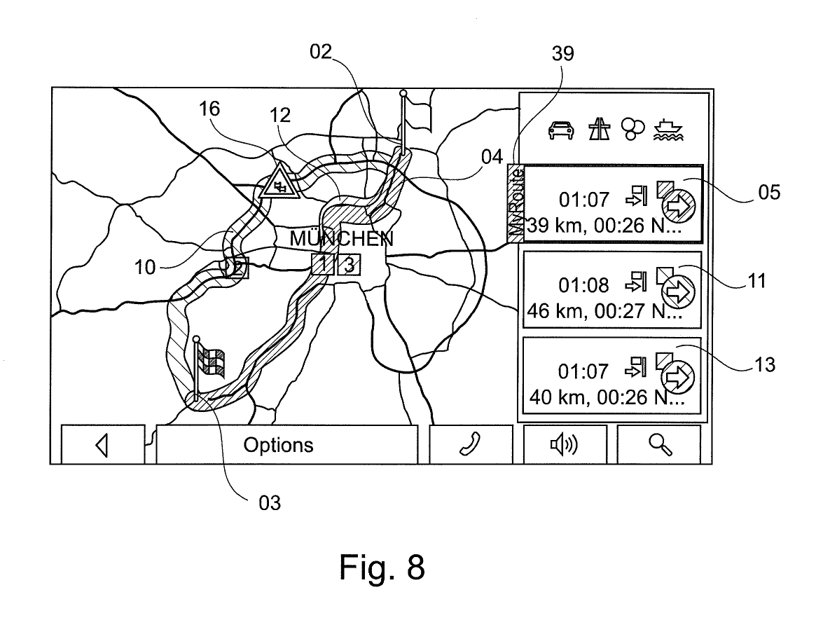

FIG. 8 shows another navigation display with three alternative routes, wherein two routes largely overlap with one another;

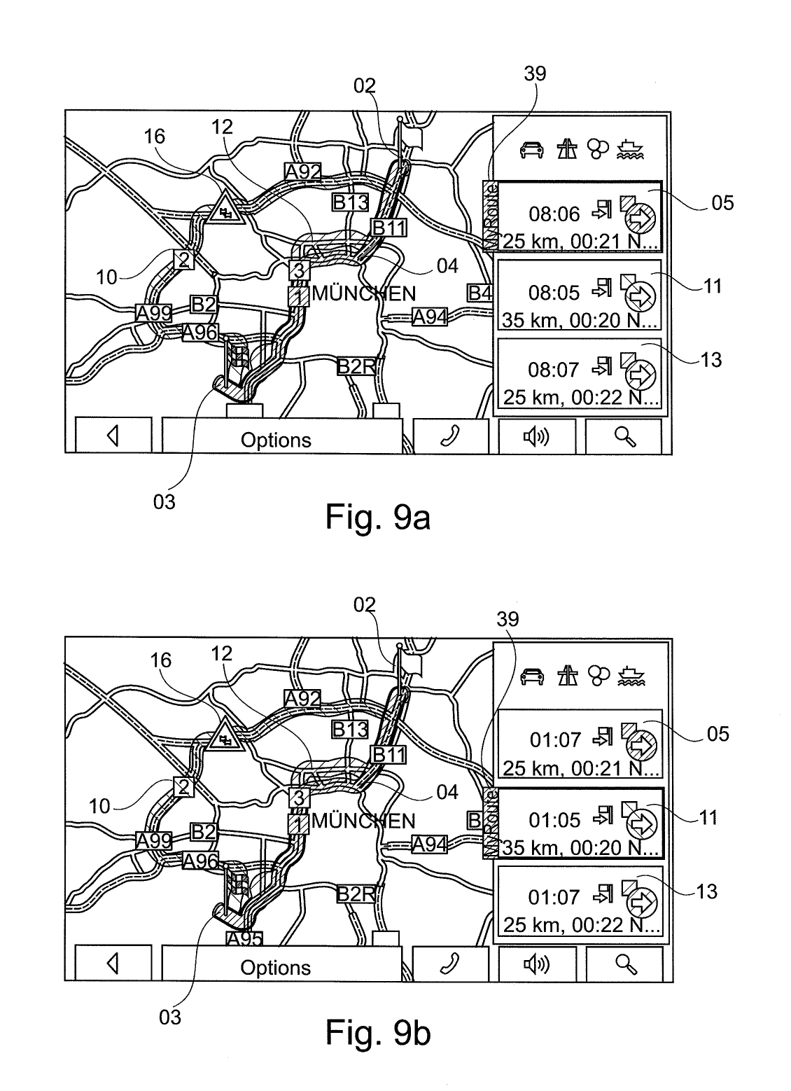

FIG. 9 shows another display of identified alternative routes at different times of day;

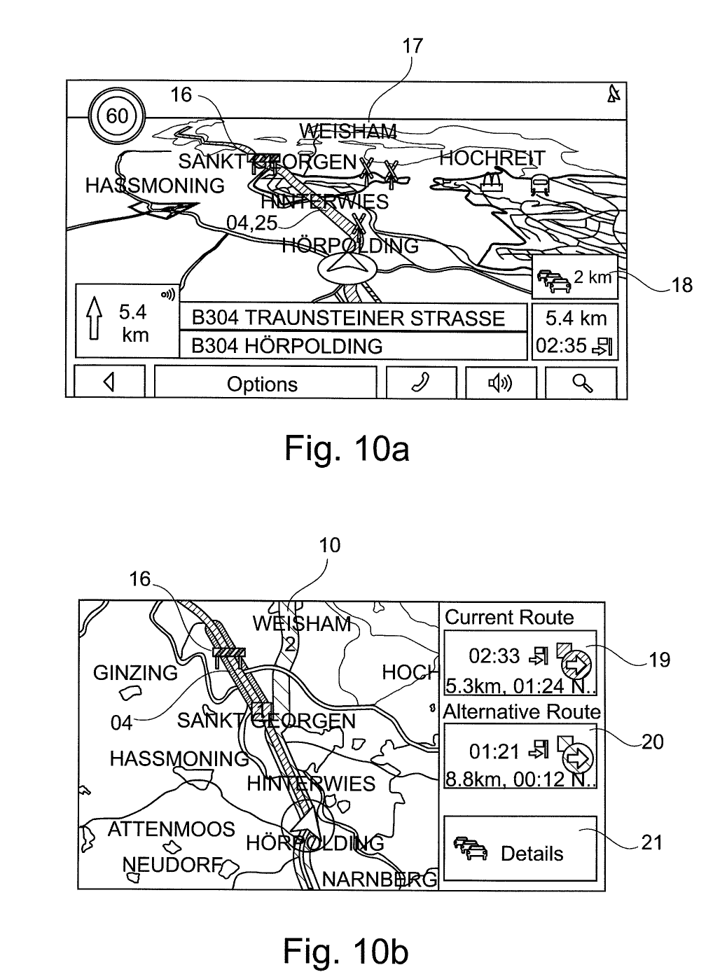

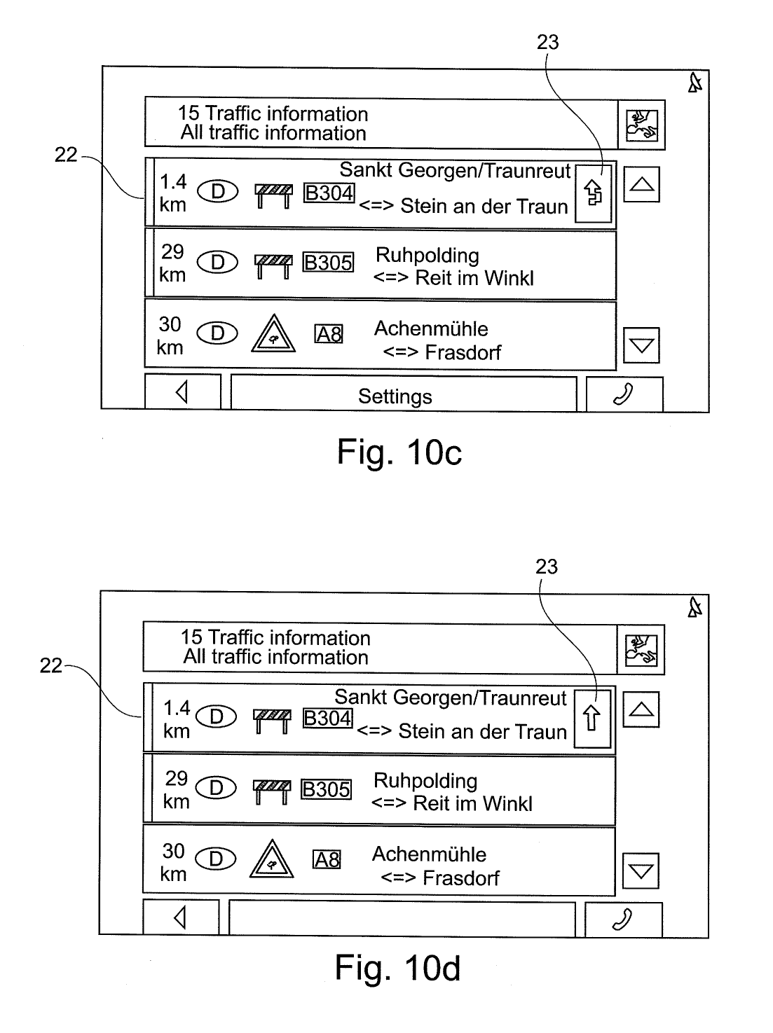

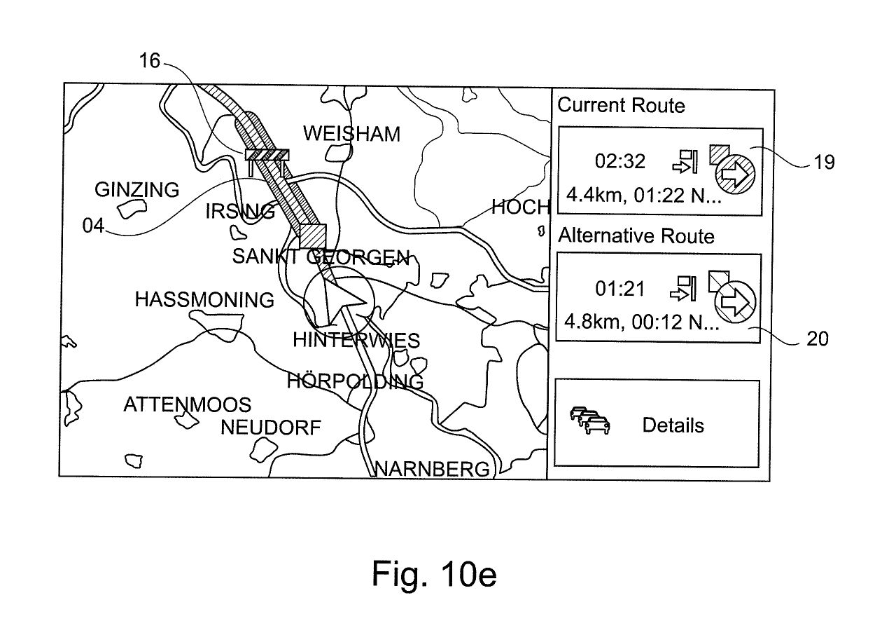

FIG. 10 shows a sequence of displays of alternative routes in the event of a traffic disturbance/traffic jam;

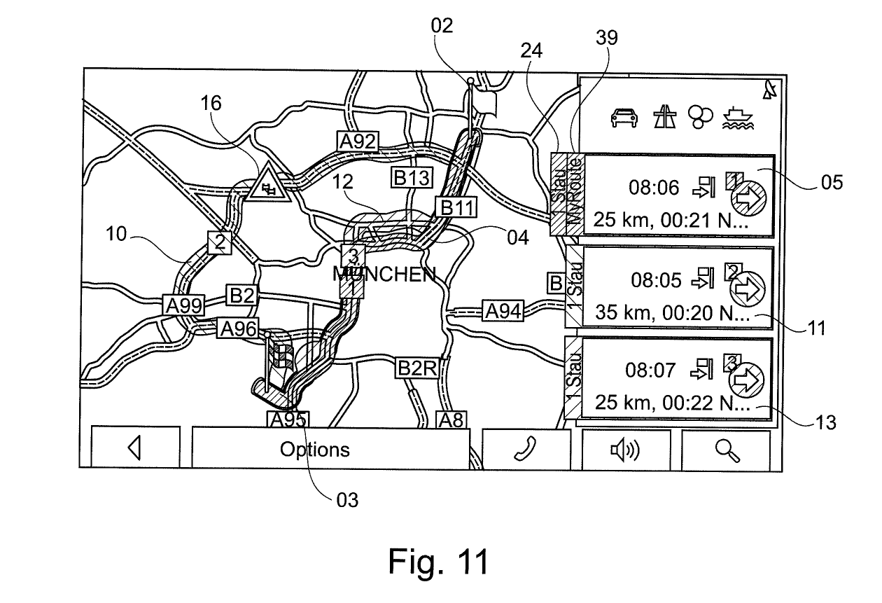

FIG. 11 shows a display of imminent traffic jams/traffic messages on calculated alternative routes;

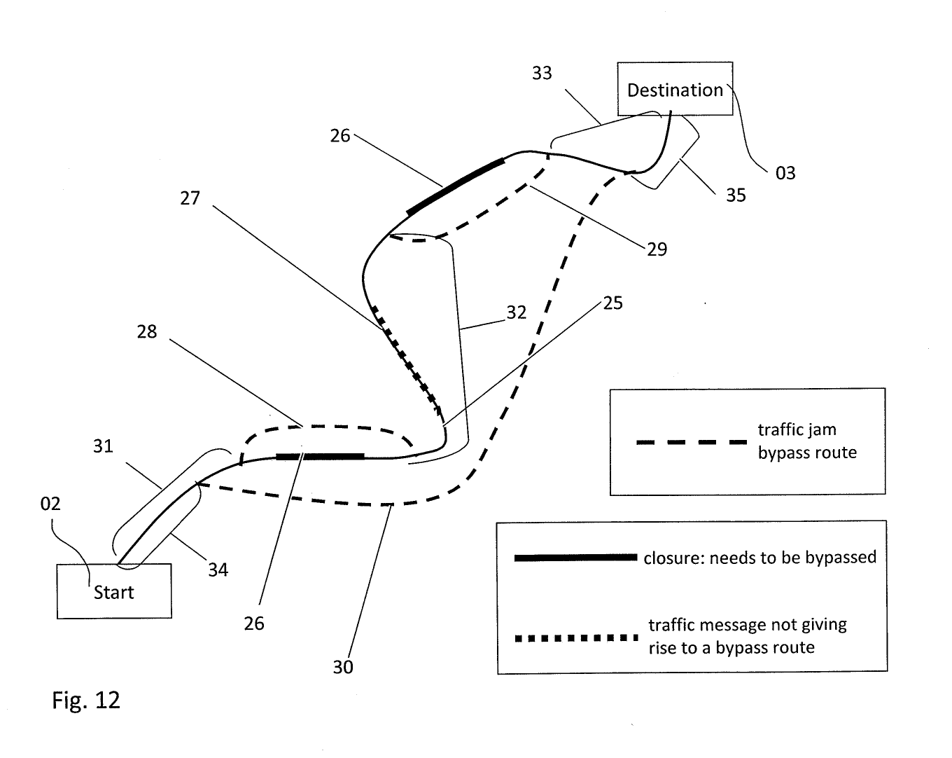

FIG. 12 shows a schematical view of a traffic jam bypass road using the inventive method.

In the figures, identical or similar elements are denoted with identical reference numerals.

FIG. 1 illustrates a first exemplary embodiment 40 of an inventive navigation device. The navigation device 40 comprises a computer system 68 which has a route calculation device 42 and a navigational guidance device 66 arranged therein. An input device 44 which comprises both a touch screen means 46 as well as a TMC reception means 48 is connected to the computer system 68. Moreover, a keyboard or a voice recognition means may be connected to the input device 44. The input device 44 further comprises a communication device 70 for communicating data specific to the driving behavior of the road profile memory to a driving behavior server (not shown), wherein the communication device 70 may communicate to the driving behavior server in a wireless or wire-bound fashion information on the driving behavior of a driver along a road and may retrieve from the driving behavior server the driving behavior of a group of users with respect to certain roads in order to be able to create realistic route plannings.

A position determining device 50, in the case at hand a GPS module, which may also be replaced by a Galileo, EGNOS, GLONASS, COMPASS or similar satellite reception module, or else a terrestrial dead reckoning module or a combination of the aforesaid components, serves for determining the instantaneous position of the vehicle and is equally connected to the computer system 68. The computer system 68 bidirectionally communicates with a memory device 52 which may store and output data. The memory device 52 comprises a map memory 54 in which roads of a digital map are stored, which can be combined to create a route with the aid of the route calculation device. Each road is allocated a road distance as well as an admissible maximum travel speed. Moreover, each road may be allocated at least one individual travel speed, preferably with a temporal profile. Besides, the memory device 52 comprises a route memory 56 in which calculated routes can be stored. Finally, the memory device 52 comprises a road profile memory 58 which is capable of storing the driving behavior of an individual user or a group of users with respect to individual roads in order to take into account realistic driving behavior profiles of the roads in the route planning.

The computer system 68, especially the route calculation device 42, is connected to a penalty attribute allocation device 60, wherein the penalty attribute allocation device 60 is configured to allocate penalty attributes to the properties of individual roads of all precalculated routes to virtually increase the average travel speed of said roads, in order to render the same unattractive for the calculation of additional routes. Moreover, the route calculation device 42 of the computer system 68 is connected to a route evaluation device 62 which compares a route with the precalculated route or all precalculated routes subsequent to the calculation of a route, and which is configured to recognize identical roads of the routes and which contains threshold values which are indicative of whether a route is highly similar to the precalculated routes or deviates from the precalculated routes to the extent that the route should be discarded. Finally, the computer system 68 is connected to an output device 64 which may output graphical or acoustic navigational guidance instructions as well as a list of the calculated routes and which may suggest the list of routes to the user for selection.

FIG. 2 illustrates a flowchart of an exemplary embodiment of the inventive method. In step S1, a destination and a starting position are entered and an instantaneous position is determined. In step S2, a route calculation of a first route is performed which is based on a selected routing strategy, for instance time-minimized or distance-minimized route or a route in avoidance of toll roads or ferries etc. In step S3, at least individual roads of the precalculated route are allocated penalty attributes in order to render said roads unattractive for the route calculation algorithm in a subsequent route calculation operation.

In step S4, the calculation of an additional route which satisfies the selected routing strategy is performed, and in step S5, an evaluation of the calculated route is performed in regard of a previously calculated route or of all of the previously calculated routes. Here the number of identical roads in contrast to the number of non-identical roads of the precalculated routes can be evaluated or the distance and traveling time of the route can be compared with the precalculated routes. If predefinable threshold values are undershot or exceeded, it can be decided to discard the currently calculated route and/or to start another route calculation. This decision is taken in step S6, especially until a predefinable number of routes, preferably three routes, have been identified. Upon completion of the route calculation operation, the routes are output to the user and a selection of a route on the part of the user is anticipated. Finally, in step S8, navigational guidance of the vehicle along the selected route is provided. If a traffic disturbance message affecting a road of the selected route is received via a traffic information system, such as RDS-TMC, the calculation operation can be performed again from the current vehicle position and alternative routes for bypassing the traffic disturbance can be sought.

The following figures exemplarily illustrate various screen output representations of an inventive navigation device which may feature conventional components, such as touch screen, virtual keyboard as well as voice output and voice input. Other types of representation are equally possible and are conceivable also in combination. In the examples, it is assumed that the user is located in a vehicle and that the vehicle can be pinpointed by a position determining device, especially GPS or dead reckoning. Here the user has selected a destination by inputting an address, selecting a special destination, clicking into the map, selecting an address book entry, performing a download from a remote server or the like.

FIG. 3 exemplarily illustrates a display in which a first route has been calculated. On map 01, the instantaneous position 02 is represented as starting point of the route and the selected destination 03 and the course of a first route 04 are represented. With the aid of map 01 in which names of places, borders, main roads and points of reference are represented, the user can be provided with an overview of the course of the first route 04. In the right field of the display, characteristic data of the first route 04 are represented in the form of a pushbutton (05). In said pushbutton, time of arrival 06, route distance 07 and predicted traveling time 08 are represented. By actuating pushbutton 05, the user is capable of selecting said route 04 for navigational guidance. In field 09 located below, a representation area for alternative routes is provided, wherein in this example, the user is notified that additional alternative routes are currently calculated.

FIG. 4 illustrates another representation of a navigation display for a different region, wherein three alternative routes 04, 10 and 12 in a travel from Bad Mergentheim to Munich have already been calculated. Here it is conceivable to calculate an arbitrary number of routes, however, in the representation of three routes, a good balance between information overflow and information overview is ensured. In addition to initially calculated route 04 which connects starting position 02 and destination 03, the course of two additional routes 10, 12 is represented on map 01, suggesting a clearly different route guidance. The details of routes 04, 10 and 12 are represented on pushbuttons 05, 11 and 13, wherein initially calculated route 04, which is selectable in pushbutton 05, is marked as route of preference 39, i.e. “MyRoute”. It is advantageous to use special colors, signatures or route markings for the representation of the routes and pushbuttons, so that a user is enabled to discern in an intuitive fashion the allocation of pushbuttons 05, 11, 13 to represented routes 04, 10, 12 on map 01. Additionally or alternatively, the route representation in map 01 and on pushbuttons 05, 11 and 13 may render apparent the relation between represented routes 04, 10 and 12 and pushbuttons 05, 11, 13 with the aid of numerical data or other markings.

Pushbutton 05 additionally features a marking 39 of the preferred route, i.e. “MyRoute”, which indicates to the user that this route is the route of preference, since this route optimally satisfies the predetermined routing strategy, e.g. fastest route or shortest route. In addition to said marked route of preference, the routes may also be sorted according to specific value K, so that the uppermost route always optimally satisfies the routing to strategy, then the second represented route etc.

After actuation of one of pushbuttons 05, 11, 13, the allocated route is selected as currently traveled route and navigational guidance is started along the selected route.

FIGS. 5 and 6 illustrate displays of exemplary embodiments of inventive navigation devices, wherein two (FIG. 5) or only one single (FIG. 6) route could be identified. The identification of two routes, as illustrated in FIG. 5, or of only one single route, as illustrated in FIG. 6, may be based on the aspect that even in the iterative increase of penalty attributes, no relevant deviations of an identified alternative route from the original route could be identified or an identified alternative route entails such increased distances or temporal losses that it does not constitute an advantageous alternative, so that the identified first route 04 or first two routes 04, 10 appear to be the most advantageous routes. In this instance, the iteration for identifying additional alternative routes is terminated. It is apparent from FIG. 6 that the destination may be directly reached in the most optimal way via route 04, and conceivable alternatives would lead to a significant increase in distance. Consequently, the provision of a termination criterion is deemed to be sensible, which prevents too large a deviation between two routes as well as too high an identity between two routes. In pushbuttons 11 and 13, the user is notified in a graphical or textual fashion that no sensible route alternatives could be identified.

FIGS. 7a and 7b exemplarily illustrate selection menus 14, 15 which initiate a route guidance simulation along a route yet to be selected. In pushbutton 14 of FIG. 7a, a simulation can be activated, wherein in submenu 15 according to FIG. 7b, the route to be simulated is initially requested. By actuating a pushbutton of route selection list 15, the route to be simulated can be selected.

FIG. 8 illustrates a screen representation of an inventive navigation device, wherein three routes 04, 10 and 12 for a travel between starting position 02 and destination 03 have already been identified and displayed to the user. In addition, by means of a corresponding symbol indicative of a traffic disturbance or a traffic jam indication 16 it is displayed on the route 10 that when pursuing the alternative route 10 which can be selected using pushbutton 11, the occurrence of a traffic jam has to be expected. This traffic jam may already have been considered in the calculation of alternative route 10, so that the indicated traveling time has been indicated with the relevant increase. The user is provided with information on the selected routes on which traffic disturbances/traffic jams have to be expected already prior to the selection of a route. If the user selects route alternative 10, the time of arrival is fraught with risk, even though pushbutton 11 indicates only a slightly longer traveling time. FIG. 8 likewise illustrates the problem of a high degree of identity of routes 04, 12, wherein initially calculated route 04 is represented on a lower projection plane than previously calculated route 12. On the same roads, previously calculated route 12 would thusly fully cover the course of route 04. In order to prevent such an instance, it is advantageous to represent route 04 previously drawn on a lower projection plane in the form of a wide route course signature compared to route 12 subsequently drawn on a higher projection plane. In the light of the aspect that on the other hand it is advantageous if the route of preference 39, which in this case represents route 04, is fully visible, provision can be made for another logic which represents the calculated routes according to their classification criterion, i.e. their identification number, wherein the route of preference 39 or the routes optimally adapted to the routing strategy are located on the uppermost projection planes. Hence, the optimally adapted route 04 of the user's routing strategy can be clearly visualized to the user.

A simple classification criterion for the representation of the route course may be the calculation sequence, i.e. the initially calculated route is the uppermost route, the last calculated route is located on the lowermost projection plane. Another criterion may be the route-specific keyword Kᵣ, wherein the recommended route, i.e. the route with the lowest specific value, is the uppermost route and hence can be drawn using the finest line.

FIGS. 9a and 9b exemplarily illustrate the identification of three route alternatives between a starting position and a destination at different times of day. Here FIG. 9a illustrates the prediction in the early morning on a working day, whereas FIG. 9b represents the same route course at night with low traffic volume. It is clearly apparent that in FIG. 9b, the traveling times are predicted to be shorter than in FIG. 9a. Hence, both figures illustrate the impact of driving-behavior-dependent speed parameters for different time intervals. FIG. 9a illustrates the result of the calculation of three route alternatives 04, 10, 12 between starting position 02 and destination 02 in the morning at the current time of 7.45. The displayed Outer Beltway of Munich is strongly frequented at this time, wherein for the road type of freeway, historical information with respect to the driving behavior and speed parameters of the user or a plurality of users are available which are indicative of the aspect that at this point of time a lower travel speed than usual can be attained. Thus, recommendation 39 suggests selecting in-town route 04, since the estimated time of arrival will be earlier. FIG. 9b illustrates the same situation at night, and the route of preference 39 is now selected as route 10 on the Outer Beltway of Munich, since the available historical information on said road type at this point of time results in a higher average speed, and hence it has to be expected that the traveling time along the Outer Beltway of Munich is shorter then the traveling time along the Inner Beltway of Munich according to route 04.

FIGS. 10a to 10e illustrate advantages of an inventive method taking into account traffic messages, for instance via an RDS-TMC traffic information channel. The navigation devices known from the state of the art generally have access to traffic messages which are preferably transmitted in line with the TMC standard in a wireless fashion, i.e. via radio band. For this purpose, a VHF receiver 48 is provided in the navigation device 40, which may read out and decode periodically transmitted traffic information. Alternatively or additionally, connections to wireless information networks, such as UMTS, GSM, HSDPA, WLAN etc. are also available, wherein for instance a connection of the navigation device via Bluetooth to a corresponding receiving device of information from remote traffic servers, especially via the Internet, can be installed. In FIG. 10a, the region in front of a user proximate to currently traveled route 04 is displayed to the user in a perspective 2.5D representation. During route guidance, traffic messages are received via a traffic information messaging system, and it is analyzed if said messages also affect roads on currently traveled route 04. With the aid of a symbol indicative of a traffic disturbance/traffic jam 16 on the route guidance screen 01, a traffic disturbance can be displayed and a pushbutton 18 may notify the user of an imminent traffic disturbance on currently traveled route 04, 25. By actuating pushbutton 18, another route calculation is initiated, preferably by means of one or more alternative routes 10, wherein the navigation screen shown in FIG. 10b is illustrated, in which the at least one alternative route is output both graphically and textually. The navigation device has now identified alternative route 10 which in fact suggests increased road distance but significantly shorter traveling time. In pushbuttons 19, 20 the user may now discern the impact of the traffic disturbance on currently traveled route 04 and the specific values resulting from the calculation of alternative route 10. In the light of the aspect that traffic disturbance 16 constitutes a full road closure, the resultant delay is considerable and the user will presumably select alternative route 10 which can in this case be marked as route of preference 39. In the event of a small impact on the time of arrival it may be advantageous to stay on original route 04, in order to thusly take into account a potential time delay of the bypass route as a result of a high volume of vehicles which are likewise intending to bypass the traffic disturbance. For this reason, it may be advantageous to be further provided with per se less attractive bypass routes or else with currently traveled route 25 afflicted with a traffic jam, even though following a traffic disturbance message several alternative routes are calculated, since it has to be expected that a plurality of vehicles which use a traffic jam bypass technology according to the known state of the art are expected to embark on nearby alternative routes, especially short bypass routes.

By actuating one of pushbuttons 19, 20, the user selects a route and this route will be adopted as currently traveled route 25 in the further navigational guidance. In addition, the user may be provided with details on the traffic disturbances by actuating pushbutton 21. In FIGS. 10c and 10d, details of the traffic disturbances are displayed in the form of a route course list in a detail menu screen 22. Here the user is provided with the option to manually manipulate the taking into account of traffic messages. By clicking into a traffic disturbance/traffic jam bypass pushbutton 23 at the end of a traffic message, in this instance a traffic message which affects currently traveled route 25, the user decides whether said traffic disturbance shall be bypassed (shown in FIG. 10c) or not bypassed (shown in FIG. 10d). If the user does not select a bypass route of the traffic disturbance, as shown in FIG. 10b, the user stays on original route 04, 25 so that the navigational guidance screen shown in FIG. 10e is represented. According to the user's selection, an alternative route is no longer displayed, but original route 04 leads to traffic disturbance 16.

FIG. 11, as an alternative illustration to FIG. 8, shows the calculation of three alternative routes 04, 10, 12 in bypassing the metropolitan area of

Munich. In information pushbuttons 05, 11, 13 for the first route 04, second route 10 and third route 12, on the one hand marking of route 04 as route of preference 39 and traffic disturbance/traffic jam information 24 regarding route 10 are superimposed, providing information on traffic disturbances 16 along route 10. Here it is represented in display 24 how many traffic messages 16 have been received on route alternative 10. Thereby, the user is provided with a clear picture of the route courses and traffic messages 16 which affect the respective route and the user is capable of taking an appropriate routing decision.

Finally, FIG. 12 schematically illustrates the course of a first route between a starting position 02 and a destination 03 drawn with a thin solid line. In this exemplary method, the navigation device 40 receives several traffic messages affecting currently traveled route 25. In this example, three traffic messages 26, 27 are available. Two traffic messages 26 give rise to a traffic jam bypass road which may for instance pass along roads 28, 29 drawn using dotted lines and it is possible to locally bypass the affected roads. Said impedimental traffic messages 26 can thereby be “shortly” bypassed. Traffic message 27 which does not lead to a bypass route is not bypassed, which aspect in the following is referred to as option 1:

In option 1, using the inventive method, currently traveled route 25 will be marked as instantaneous route and a traffic jam bypass route which may for instance pass along alternative routes 31, 28, 32, 29 and 33 will be created. Taking into account driving-behavior-dependent speed data, a recommendation for an alternative route is calculated.

Moreover, a second option can be considered to bypass a traffic jam: Said traffic jam bypass route would result in an extensive bypass route of all of the three traffic disturbance messages affecting sections 34, 30 and 35, and would constitute a concrete alternative route to currently traveled route 25. In this case too, a traffic jam bypass route would be enabled taking into account driving-behavior-dependent speed data which might give rise to different results as a function of the time of day, day of the week and season. The decision on which of the aforementioned options are suggested to the user by the navigation device 40 depends upon the concrete implementation and can be performed alternatively or additionally, so that short bypass options according to option 1 as well as extensive bypass routes according to option 2 can be given equal treatment.

The inventive method and the inventive navigation device allow identifying the optimal way to bypass a traffic jam or traffic jams or a combination of traffic disturbances and traffic jams. This is enabled by allocating penalty attributes to roads of a currently traveled route, wherein the routing strategy disregards roads of precalculated routes in order to be capable of identifying optimal alternative routes. By means of this measure, traffic flow is eased, the user is informed according to his/her requirements and dynamic traffic guidance is enabled taking into account historical driving behavior data.

1.-14. (canceled)

15. A method for navigating a vehicle along a route from a starting position or an instantaneous position to a destination, wherein a route calculation device of a navigation device calculates a route course which is composed of a sequence of several coherent roads stored on a digital map of a memory device as a first route, and wherein at least one alternative route is additionally calculated by allocating one or more penalty attribute(s) to at least one road of the first route, comprising the following steps of:
S1: entering at least one destination;
S2: calculating a first route;
S3: allocating a penalty attribute to at least one road of the first route;
S4: calculating at least one additional route;
S7: representing the routes and selecting a route; and
S8: providing navigational guidance along the selected route.

16. The method for navigating a vehicle along a route from a starting position or an instantaneous position to a destination according to claim 15, wherein the penalty attribute(s) are selected from the group consisting of increased average traveling time, road distance and combinations thereof.

17. The method according to claim 15, further comprising the intermediate steps of:
S5: comparing and evaluating the additional route with regard to the precalculated route or routes;
S6: deciding whether to calculate an additional route as a function of the evaluation result and/or deciding whether to discard the additional route as a function of the evaluation result, wherein the penalty attribute is adapted for another route calculation until a predeterminable number of routes has been calculated.

18. The method according to claim 17, wherein precalculated route or routes are compared and evaluated in terms of the route distance, traveling time, number of identical roads or combinations thereof.

19. The method according to claim 17, wherein the evaluation result is determined in respect of identity of roads, route distance and traveling time, subject to a predeterminable absolute or relative measure.

20. The method according to claim 17, wherein the predeterminable number of routes is three routes.

21. The method according to claim 15, wherein in the calculation and/or evaluation of a route, the individual driving behavior of a user and/or a group of users is regarded in respect of individual roads and/or road types.

22. The method according to claim 21, wherein the individual driving behavior is the time-of-day-related driving behavior.

23. The method according to claim 15, wherein the penalty attribute can be determined in an adaptive fashion at least for individual road types including individual roads of a route, and/or the penalty attribute to be allocated to individual road types or individual roads can be determined by the individual driving behavior of a user and/or a group of users.

24. The method according to claim 23, wherein the penalty attribute allocated to each road can be determined as a function of the distance from the starting position and/or destination and/or as a function of the road type structure of a route.

25. The method according to claim 15, wherein the representation of the route course comprises graphical markings of the route course as well as route markings for distinguishing overlapping roads, and/or a textual representation of the routes comprises essential route evaluation information.

26. The method according to claim 25, wherein the graphical markings include color, the route markings include different route representation widths and the essential route evaluation information is selected from the group consisting of traveling time, time of arrival, road types, traffic status information or a combination thereof.

27. The method according to claim 15, wherein information on traffic jams/traffic disturbances is received via a traffic messaging system, and each disturbance is represented specific to each route and is incorporated into the determination of the penalty attributes and/or evaluation of the route.

28. The method according to claim 27, wherein the traffic messaging system is selected from the group consisting of RDS-TMC, GSM, GPRS, UMTS, HSDPA, WLAN and WiMax.

29. The method according to claim 27, wherein the penalty attributes and/or evaluation of the route includes a time loss value or closure of a road of the route

30. The method according to claim 27, wherein upon reception of a traffic message affecting currently traveled route and based on the instantaneous position, additional routes for bypassing the traffic jam/traffic disturbance are calculated, wherein in addition, the instantaneous route is represented as one of the alternative routes.

31. The method according to claim 15, wherein in the representation of the calculated routes, a route marked in terms of a preference criterion is recommended as a route of preference.

32. The method according to claim 31, wherein in selecting the route, the route of preference is selected as instantaneous route subsequent to the lapse of a predeterminable selection time in which no selection is performed on the part of the user.

33. The method according to claim 31 wherein the route is marked as a distance-optimized or traveling-time-optimized route.

34. A navigation device for performing a method for navigating a vehicle along a route from a starting position or an instantaneous position to a destination, wherein a route calculation device of a navigation device calculates a route course which is composed of a sequence of several coherent roads stored on a digital map of a memory device as a first route, and wherein at least one alternative route is additionally calculated by allocating one or more penalty attribute(s) to at least one road of the first route, comprising the following steps of:
S1: entering at least one destination;
S2: calculating a first route;
S3: allocating a penalty attribute to at least one road of the first route;
S4: calculating at least one additional route;
S7: representing the routes and selecting a route; and
S8: providing navigational guidance along the selected route;
the navigation device comprising:
an input device for inputting at least one destination of a navigation operation;
a position determining device for determining an instantaneous positon of the vehicle;
a memory device for storing at least road courses of a digital map and the calculated routes;
a route calculation device for calculating a route between a starting position or an instantaneous position and a destination;
a navigational guidance device for continuously determining navigational instructions during the travel of the vehicle along a selected route;
an output device for outputting a representation of at least two routes and for outputting navigational instructions;
a penalty attribute allocation device for allocating penalty attributes;
wherein the route calculation device is adapted to calculate at least two routes between starting position or instantaneous position and destination taking into account the route calculation requirement, and the penalty attribute allocation device is configured to allocate penalty attributes to at least individual roads of the first route after calculation of a first route, so that an alternative route can be calculated in another route calculation.

35. The device according to claim 34, wherein the route calculation device for calculating a route between a starting position or an instantaneous position and a destination calculates the route subject to an input route calculation requirement comprising traveling-time-optimized or distance-optimized route.

36. The device according to claim 34, whereinpenalty attributes allocated by the penalty attribute allocation device include additional road distance or additional traveling time to at least one road of at least one precalculated route.

37. The device according to claim 34, further comprising a route evaluation device for evaluating properties of the precalculated route or routes.

38. The device according to claim 37 wherein the route evaluation device valuates properties of the precaluculated route or routes including route distance, traveling time, number of identical roads and combinations thereof, wherein the penalty attribute allocation device is configured to allocate modified penalty attributes to at least individual roads of the precalculated routes on the basis of an evaluation result of the route evaluation device.

39. The device according to claim 34 wherein the input device comprises a selection means for selecting a route and a timing means for automatically selecting the route of preference.

40. The device according to claim 34, wherein the memory device further comprises a road profile memory for storing an individual driving behavior.

41. The device according to claim 40 wherein the individual driving behavior includes time-of-day-related driving behavior of a user and/or a group of users on at least one road, wherein the driving behavior along a road can be recorded and stored in the road profile memory and the driving behavior can be recorded and stored during a travel, and a road-related driving behavior can be retrieved from the road profile memory in the route planning.

42. The device according to claim 34, wherein the device further comprises a communication device for wireless or wire-bound communication of an individual driving behavior of a user and/or driving behavior of a group of users on at least one road between the road profile memory and a driving behavior server.

43. The device according to claim 42, wherein the driving behavior server, is selected from the group consisting of GSM, GPRS, UMTS, HSDPA, WLAN, and WiMax in a wireless fashion or else via LAN, the Internet and USB in a wire-bound fashion.
